(19) United States
(12) Patent Application Publication
(10) Pub. No.: US 2026/0175733 A1
(43) Pub. Date: Jun. 25, 2026

(54) CHARGING CONTROL METHOD AND CHARGING CONTROL APPARATUS

(71) Applicant: Panasonic Intellectual Property Management Co., Ltd., Osaka (JP)

(72) Inventors: JUN HIRANO, Osaka (JP); TAKASHI MURAKAMI, Osaka (JP)

(21) Appl. No.: 19/541,467

(22) Filed: Feb. 17, 2026

Related U.S. Application Data
(63) Continuation of application No. PCT/JP2025/015069, filed on Apr. 17, 2025.

(30) Foreign Application Priority Data
May 24, 2024 (JP) 2024-084570

(51) Int. Cl. B60L 53/66; B60L 53/14; B60L 58/12

(52) U.S. Cl. CPC B60L 53/665; B60L 53/14; B60L 58/12

(57) ABSTRACT

A charging control method includes receiving, from a first external device when an electric vehicle is connected to a charger, a first identifier for identifying a charging schedule planned in advance for the electric vehicle, receiving, from a second external device, a second identifier of the charger to which the electric vehicle is connected, and determining whether the second identifier and a third identifier of a charger scheduled to be used in the charging schedule associated with the first identifier are same. Even if the second identifier and the third identifier are different from each other, the charger to which the electric vehicle is connected performs charging control for the electric vehicle.

### BACKGROUND

### Technical Field

The present disclosure relates to a charging control method and a charging control apparatus.

### Description of the Related Art

Charging of electric vehicles is being examined. Japanese Unexamined Patent Application Publication No. 2011-139580 describes a charging apparatus having a function of permitting charging only for electric vehicles owned by users registered in advance.

### SUMMARY

One non-limiting and exemplary embodiment provides techniques suitable for improving convenience of a user of an electric vehicle.

In one general aspect, the techniques disclosed here feature a charging control method including receiving, from a first external device when an electric vehicle is connected to a charger, a first identifier for identifying a charging schedule planned in advance for the electric vehicle, receiving, from a second external device, a second identifier of the charger to which the electric vehicle is connected, and determining whether the second identifier and a third identifier of a charger scheduled to be used in the charging schedule associated with the first identifier are same. Even if the second identifier and the third identifier are different from each other, the charger to which the electric vehicle is connected performs charging control for the electric vehicle.

The techniques according to the present disclosure are suitable for improving convenience of a user of an electric vehicle.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is an explanatory diagram of an environment according to a first embodiment.

FIG. 2 is a sequence diagram illustrating an example of operation of a charging system and an external system according to the first embodiment; and

FIG. 3 is a flowchart illustrating the example of the operation of the charging system and the external system according to the first embodiment.

### DETAILED DESCRIPTIONS

### Underlying Knowledge Forming Basis of Present Disclosure etc.

A case where a charging schedule for charging an electric vehicle using a first charger is planned is assumed. It is possible to construct a mechanism that, if the electric vehicle is connected to not the first charger but a second charger, the second charger is inhibited from charging the electric vehicle.

The mechanism, however, has room for improvement from the perspective of improving convenience of a user. A mechanism that can charge an electric vehicle using an unintended charger even if the electric vehicle is connected to the unintended charger can improve convenience of a user of the electric vehicle.

Embodiments of the present disclosure will be described hereinafter with reference to the drawings. The present disclosure is not limited to the following embodiments.

### First Embodiment

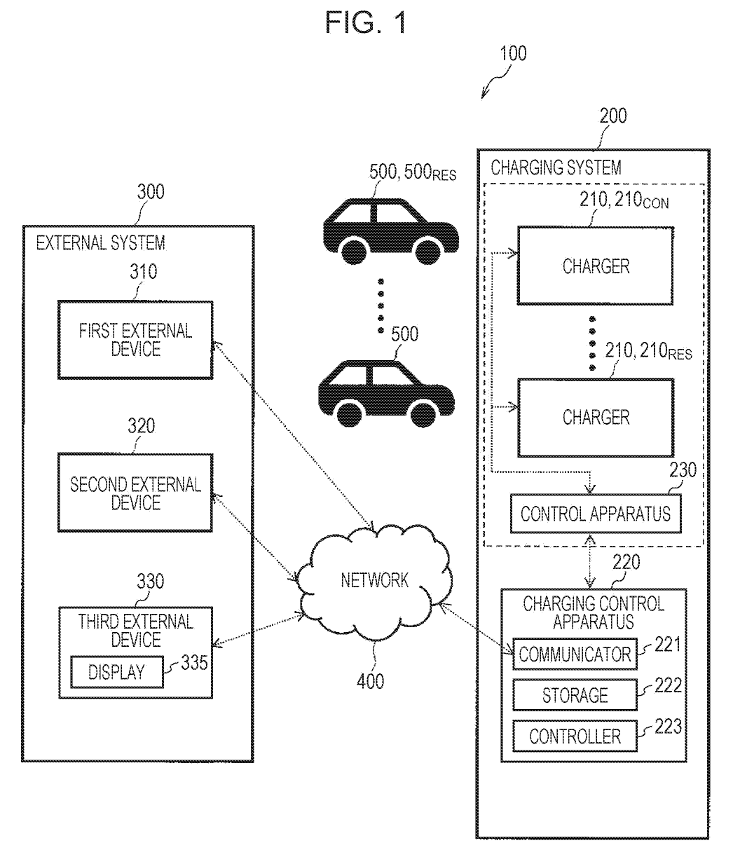

A first embodiment will be described hereinafter with reference to FIGS. 1 to 3.

### Configuration of Environment 100

### Outline of Configuration of Environment 100

FIG. 1 is an explanatory diagram of an environment 100 according to the first embodiment.

The environment 100 includes a charging system 200, an external system 300, a network 400, and a plurality of electric vehicles 500.

The charging system 200 is connected to the external system 300 via the network 400, and can communicate with the external system 300 via the network 400. As a result, the charging system 200 can operate in coordination with the external system 300. Under the coordination, the charging system 200 can charge the electric vehicles 500.

The components in the environment 100 will be described in detail hereinafter.

### Charging System 200

The charging system 200 includes a plurality of chargers 210, a control apparatus 230, and a charging control apparatus 220.

The plurality of chargers 210 is provided in a parking lot. Specifically, the parking lot is provided with a plurality of parking spaces. A charger 210 is provided in at least one of the plurality of parking spaces. Typically, a charger 210 is provided in each parking space. Each charger 210 can charge an electric vehicle 500 connected thereto. Specifically, each electric vehicle 500 includes a power storage apparatus, which can be charged by the chargers 210.

The control apparatus 230 collects information from the plurality of chargers 210. The control apparatus 230 is disposed at a site (on-site) where the chargers 210 are disposed. The control apparatus 230 includes a gateway and a controller.

The charging control apparatus 220 manages charging by each charger 210. In the present embodiment, the charging control apparatus 220 is a server. The charging control apparatus 220 includes a communicator 221, a storage 222, and a controller 223. The storage 222 includes a correspondence table.

In the present embodiment, a control command from the charging control apparatus 220 is given to each of the plurality of chargers 210 via the control apparatus 230. In the charging system 200, the charging control apparatus 220 and the control apparatus 230 may be connected to each other via the network 400 and communicate with each other via the network 400, or may be connected to each other without using the network 400 and communicate with each other without using the network 400.

The communication between the control apparatus 230 and the charging control apparatus 220 may be wired communication or wireless communication. The communication between the control apparatus 230 and the plurality of chargers 210 may be wired communication or wireless communication.

### External System 300

The external system 300 is located outside the charging system 200. The external system 300 includes a first external device 310, a second external device 320, and a third external device 330. The third external device 330 includes a display 335.

In the present embodiment, the external system 300 is a dispatch system. The dispatch system creates a dispatch plan for the plurality of electric vehicles 500.

The communicator 221, the first external device 310, the second external device 320, and the third external device 330 are connected to each other via the network 400, and can communicate with each other via the network 400. The plurality of chargers 210, the first external device 310, the second external device 320, and the third external device 330 are connected to each other via the control apparatus 230, the communicator 221, and the network 400, and can communicate with each other via the control apparatus 230, the communicator 221, and the network 400. The network 400 is, for example, the Internet.

The external system 300 provides an external service. The charging control apparatus 220 provides a charging service. The charging service includes charging of the electric vehicles 500. The charging service cooperates with the external service by giving a right to be charged by the chargers 210 to the electric vehicles 500 in periods reserved by the external service. In the present embodiment, the external service is a dispatch service, and includes operation management of the plurality of electric vehicles 500 according to a dispatch plan.

The dispatch plan includes, for example, at least one plan selected from the group consisting of: (a) a plan of a periods for which a user uses an electric vehicle 500; (b) a plan of a maintenance period of an electric vehicles 500; and (c) a plan of a period for which an electric vehicle 500 is parked in a parking space of the charging system 200.

The charging control apparatus 220 provides the charging service while referring to the plan (c). The charging control apparatus 220 may estimate the plan (c) on the basis of the plan (a) and/or the plan (b).

### Example of Operation of Charging System 200 and External System 300

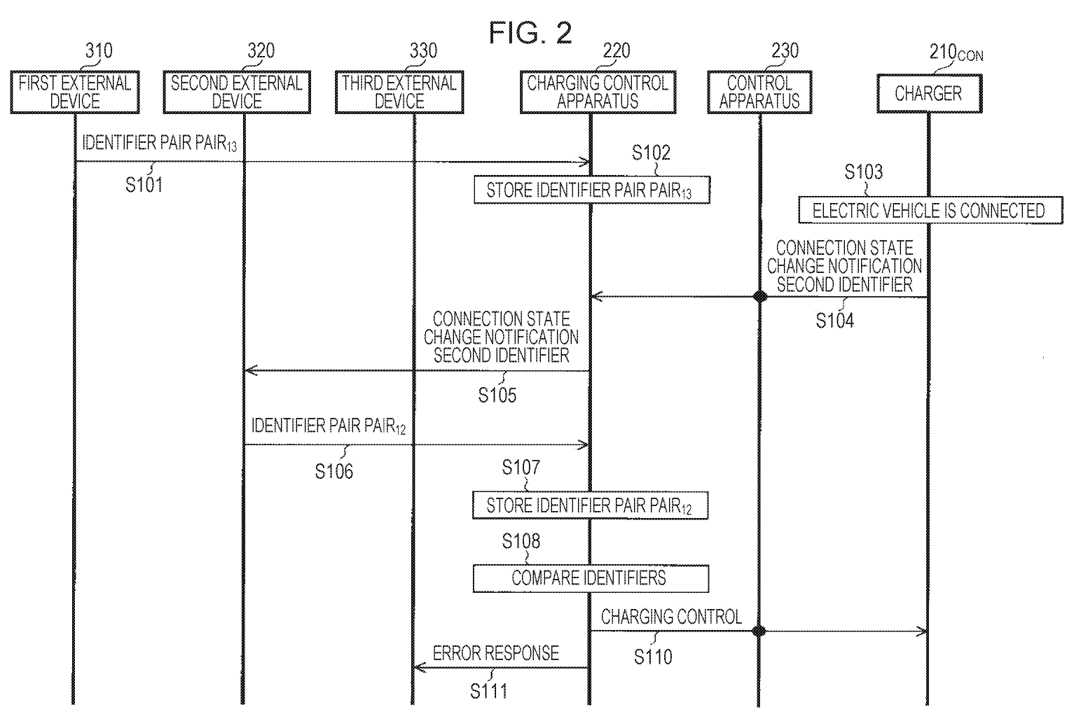

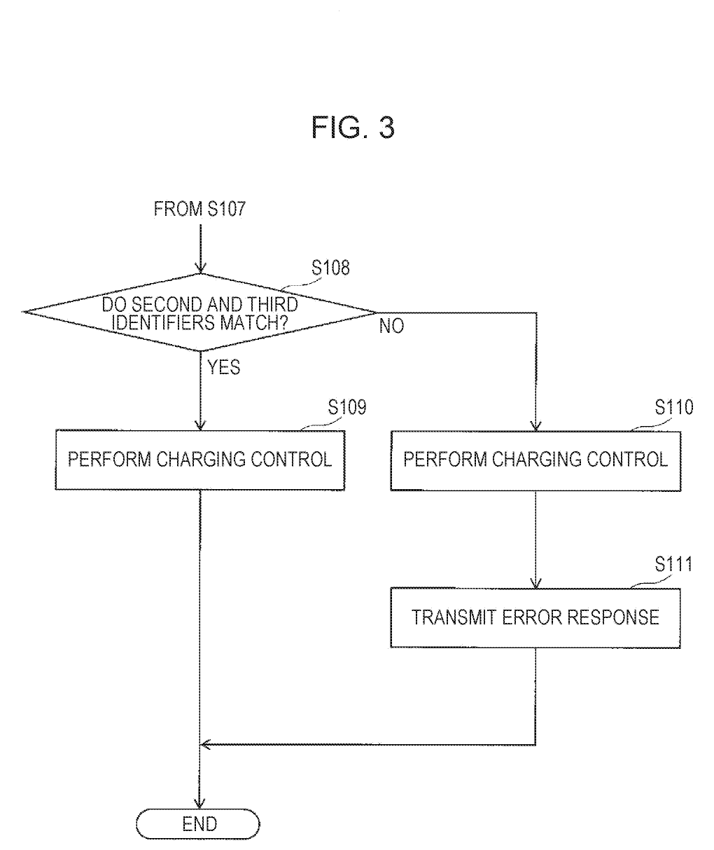

FIG. 2 is a sequence diagram illustrating an example of operation of the charging system 200 and the external system 300 according to the first embodiment. FIG. 3 is a flowchart illustrating the example of the operation of the charging system 200 and the external system 300 according to the first embodiment.

In the present embodiment, a charging reservation is planned in advance before step S101 of the sequence diagram of FIG. 2. The charging reservation includes a charging schedule for charging a particular electric vehicle 500 (hereinafter an electric vehicle 500_{RES}) using a particular charger 210 (hereinafter a charger 210_{RES}) in a charging reservation period T_{RES}. Before step S101 of the sequence diagram of FIG. 2, the charging reservation is stored in the external system 300 and accessible from the first external device 310, the second external device 320, and the third external device 330.

Steps S101 to S107 will be described with reference to FIG. 2. Steps S108 to S111 will be described with reference to FIGS. 2 and 3. Note that FIG. 2 illustrates a case where "NO" is determined in S108.

In step S101, the first external device 310 transmits an identifier pair PAIR₁₃ to the communicator 221 via the network 400. As a result of the transmission in step S101, the controller 223 receives the identifier pair PAIR₁₃ via the communicator 221.

The identifier pair PAIR₁₃ is a pair of a first identifier and a third identifier. The first identifier is an identifier for identifying the charging schedule planned in advance for the electric vehicle 500_{RES}. The third identifier is an identifier of the charger 210_{RES} scheduled to be used in the charging schedule. The third identifier is associated with the first identifier.

In the present embodiment, the first identifier is also associated with time information regarding the charging schedule of the electric vehicle 500_{RES}. That is, the time information regarding the charging schedule can be referred to on the basis of the first identifier. Specifically, the time information regarding the charging schedule includes information indicating the charging reservation period T_{RES}. More specifically, the time information regarding the charging schedule includes information indicating a start time and an end time of the charging reservation period T_{RES}.

Next, in step S102, the controller 223 stores the identifier pair PAIR₁₃ in the correspondence table in the storage 222. Specifically, the identifier pair PAIR₁₃ is stored in the correspondence table in association with each other.

In step S103, an electric vehicle 500 is connected to a charger 210. In the following description, the charger 210 connected to the electric vehicle 500 in step S103 will also be referred to as a charger 210_{CON}.

As a result of the connection in step S103, the charger 210_{CON} detects a change in a connection state. Here, the change in the connection state is a change from a state where no electric vehicle 500 is not connected to the charger 210_{CON} to a state where an electric vehicle 500 is connected to the charger 210_{CON}.

Next, in step S104, the charger 210_{CON} transmits a connection state change notification and a second identifier to the communicator 221 via the control apparatus 230.

Next, in step S105, the controller 223 causes the communicator 221 to transmit the connection state change notification and the second identifier to the second external device 320 via the network 400.

As a result of steps S104 and S105, the connection state change notification and the second identifier are transmitted from the charger 210_{CON} to the second external device 320 via the control apparatus 230, the charging control apparatus 220, and the network 400. The connection state change notification includes information indicating the occurrence of the change in the connection state and information indicating a time of the occurrence of the change in the connection state. The second identifier is an identifier of the charger 210_{CON}.

Next, in step S106, the second external device 320 transmits an identifier pair PAIR₁₂ to the communicator 221 via the network 400 in response to reception of the connection state change notification and the second identifier. The identifier pair PAIR₁₂ is a pair of the first identifier and the second identifier. As a result of the transmission in step S106, the controller 223 receives the identifier pair PAIR₁₂ via the communicator 221.

In step S106 according to a specific non-limiting example of operation, the second external device 320 recognizes the time of the occurrence of the change in the connection state on the basis of the connection state change notification received in step S105. In this specific example of operation, the second external device 320 determines that the time of occurrence of the change in the connection state coincides with the start time of the charging reservation period T_{RES} in the charging reservation of the electric vehicle 500_{RES}. The second external device 320 then accesses the first identifier associated with the time information regarding the charging schedule. The second external device 320 then transmits the first identifier to the communicator 221 via the network 400 along with the second identifier.

Next, in step S107, the controller 223 stores the identifier pair PAIR₁₂in the correspondence table in the storage 222. Specifically, the identifier pair PAIR₁₂ is stored in the correspondence table in association with each other.

Next, in step S108, the controller 223 compares the second identifier and the third identifier. As illustrated in FIG. 3, if it is determined in step S108 that the second identifier and the third identifier match, the process proceeds to step S109. If it is determined that the second identifier and the third identifier do not match, on the other hand, the process proceeds to step S110.

Specifically, in step S108, the controller 223 searches the storage 222 for pairs including the first identifier. As a result, the identifier pair PAIR₁₂ and the identifier pair PAIR₁₃ are found. The controller 223 extracts the second identifier of the identifier pair PAIR₁₂ and the third identifier of the identifier pair PAIR₁₃. The controller 223 then determines whether the extracted second and third identifiers match. The controller 223 thus determines in step S108 whether the second and third identifiers extracted through the search match using the first identifier as an index for the search.

Matching between the second identifier and the third identifier in step S108 means that the charger 210_{CON} and the charger 210_{RES} are the same charger, that is, the electric vehicle 500_{RES} has been connected to the reserved charger 210. Mismatching between the second identifier and the third identifier in S108, on the other hand, means that the charger 210_{CON} and the charger 210_{RES} are different chargers, that is, the electric vehicle 500_{RES} has been connected to a charger 210 different from the reserved charger 210. Note that FIG. 1 illustrates a situation where the charger 210_{CON} and the charger 210_{RES} are different chargers.

In the present embodiment, the controller 223 performs charging control for the charger 210_{CON} not only in step S109 but also in step S110. As a result, a current flows from the charger 210_{CON} to the electric vehicle 500_{RES} to charge the electric vehicle 500_{RES}. Specifically, the controller 223 performs the charging control for the charger 210_{CON} via the control apparatus 230.

After step S110, in step S111, the controller 223 causes the communicator 221 to transmit an error response to the third external device 330 via the network 400. In the first embodiment, an error response includes information indicating an abnormality. The transmission in step S111 enables the third external device 330 to address the abnormality. In the present embodiment, the display 335 of the third external device 330 displays the information indicating the abnormality.

In the present embodiment, the external system 300 is a dispatch system. The transmission in step S111 enables the third external device 330 to address the abnormality and optimize dispatching. The optimization is, for example, a change to the dispatch plan for the plurality of electric vehicles 500.

As can be understood from the above description, in the present embodiment, each electric vehicle 500 can be charged by a charger 210 connected thereto regardless of whether the electric vehicle 500 is connected to a reserved charger 210 or connected to a charger 210 different from the reserved charger 210. This improves convenience of a user of the electric vehicle 500.

Some other embodiments will be described hereinafter. In the following description, elements common between the above-described embodiment and a subsequently described embodiment will be given the same reference signs, and description thereof may be omitted. Description of these embodiments can be mutually applied insofar as no technical contradiction is caused. The description of these embodiments may be combined together unless no technical contradiction is caused.

### Second Embodiment

In a second embodiment, the error response in step S111 includes information indicating that the charger 210_{RES} and the charger 210_{CON} are different chargers. The display 335 of the third external device 330 displays the information indicating that the charger 210_{RES} and the charger 210_{CON} are different chargers.

### Third Embodiment

In a third embodiment, the error response in step S111 includes information indicating that the charging schedule needs to be corrected. The display 335 of the third external device 330 displays the information indicating that the charging schedule needs to be corrected.

### Comparison between First Embodiment, Second Embodiment, and Third Embodiment

With the error response in step S111 according to the second embodiment, as compared with the error response in step S111 according to the first embodiment, detailed abnormality information regarding the connection between the electric vehicle 500 and the charger 210 can be given to the third external device 330. With the error response in step S111 according to the third embodiment, as compared with the error response in step S111 according to the second embodiment, detailed abnormality information regarding the connection between the electric vehicle 500 and the charger 210 can be given to the third external device 330.

A responsibility demarcation point between a manager of the charging system 200 and a manager of the external system 300 is considered. For example, the second embodiment can be employed when a range of responsibility to be covered by the manager of the charging system 200 is wider than in the first embodiment. The third embodiment can be employed when the range of responsibility to be covered by the manager of the charging system 200 is wider than in the second embodiment.

Step S111 can be implemented on the basis of Hypertext Transfer Protocol (HTTP). In an example, the information indicating an abnormality in step S111 according to the first embodiment corresponds to an HTTP error, and specifically corresponds to any of HTTP errors in a 400 series or a 500 series. The information indicating that the charger 210_{RES} and the charger 210_{CON} in step S111 according to the second embodiment corresponds to an HTTP error code indicating occurrence of mismatching between chargers. The information indicating that the charging schedule needs to be corrected in step S111 according to the third embodiment is a message included in an HTTP body.

In addition, in the second embodiment and the third embodiment, since the charging control is performed as an effect of the techniques according to the present disclosure, a response can be made using an HTTP 200 OK response or the like, and the error code (second embodiment) or the body message (third embodiment) indicating that an operation is not performed with a correct correspondence can also be transmitted. As a result, an operation situation where the charging system 200 is normally providing the service for the electric vehicle 500_{RES} but there is a problem with consistency of states between the systems can be conveyed more accurately.

### Techniques Applicable to First to Third Embodiments

Techniques applicable to the first to third embodiments described above will be described hereinafter.

In the first to third embodiments described above, the external system 300 is a dispatch system. The external system 300 may be another system such as a vehicle operation system, a social infrastructure system, or an inter-operator coordination platform.

In the first to third embodiments described above, a plurality of electric vehicles 500 is compatible with the charging system 200. Only one electric vehicle 500, however, may be compatible with the charging system 200, instead.

In the first to third embodiments described above, the charging system 200 includes a plurality of chargers 210. The charging system 200, however, may include only one charger 210, instead.

A charger is a concept encompassing a charge/discharge device. When the charger 210 is a charge/discharge device, the charger 210 can be connected to an electric vehicle 500 and receive power supplied from the electric vehicle 500. As a result, power can be discharged from the electric vehicle 500. The charger 210 may or may not be a charge/discharge device.

The charger 210 may include a display. For example, the error response in step S111 is transmitted to the charger 210 via the control apparatus 230. In the first embodiment, the display of the charger 210 displays the information indicating the abnormality. In the second embodiment, the display of the charger 210 displays the information indicating that the charger 210_{RES} and the charger 210_{CON} are different chargers. In the third embodiment, the display of the charger 210 displays the information indicating that the charging schedule needs to be corrected.

In the first to third embodiments described above, the first external device 310 may be, for example, a server of the external system 300 or an information terminal owned by a user of an electric vehicle 500. The second external device 320 may be a server of the external system 300 or an information terminal owned by a user of an electric vehicle 500. The third external device 330 may be an information terminal including the display 335 in the external system 300 or an information terminal owned by a user of an electric vehicle 500. The example illustrated in FIG. 1 corresponds to a case where the first external device 310 is a server of the external system 300, the second external device 320 is another server of the external system 300, and the third external device 330 is the information terminal including the display 335 in the external system 300.

The external system 300 is a dispatch system or a vehicle operation system. When the third external device 330 is the information terminal including the display 335 in the external system 300, the information terminal receives an error response relating to an operation. The information terminal is a device or a sub-system including a user interface (UI) for monitoring and controlling operations and notifying a system manager or a user.

When at least two of the first external device 310, the second external device 320, and the third external device 330 are devices of the same type, a single device may serve as these devices. For example, when the first external device 310 and the second external device 320 are servers of the external system 300, a single server may serve as the first external device 310 and the second external device 320. In addition, when the first external device 310, the second external device 320, and the third external device 330 are information terminals of a user of an electric vehicle 500, a single information terminal may serve as the first external device 310, the second external device 320, and the third external device 330.

Each electric vehicle 500 may be a four-wheeled vehicle or may be a two-wheeled vehicle. Each electric vehicle may be a private vehicle or may be a commercial vehicle. In addition, each electric vehicle 500 may be an automatic guided vehicle (AGV).

In the first to third embodiments described above, electric transportation apparatuses (electric mobile bodies) are the electric vehicles 500. The electric mobile bodies, however, are not limited to the electric vehicles 500. Other examples of the electric mobile bodies include drones, electric vessels, electric aircraft (so-called "flying cars"), fixed-wing aircraft, and rotary-wing aircraft. In the first to third embodiments described above, "electric vehicles 500" may be replaced with "electric mobile bodies".

An apparatus may serve as two of the first external device 310, the second external device 320, and the third external device 330, and another apparatus may serve as the remaining one device.

The power storage apparatus included in each electric vehicle 500 is not particularly limited. The power storage apparatus may include a storage battery or may include a capacitor. The storage battery is, for example, a lithium-ion secondary battery. The power storage apparatus may include one or both of a storage battery and a capacitor.

Order, content, and the like of the steps of the flowchart and the sequence diagram described above may be changed as appropriate. In addition, the above-described control need not necessarily be performed in accordance with the flowchart and the sequence diagram. The above-described control may be implemented, for example, using a state transition machine.

In step S101 according to the first to third embodiments described above, the first external device 310 transmits the first and third identifier to the communicator 221 via the network 400.

In step S101 according to a modification of the first to third embodiments, the first external device 310 transmits the first identifier to the communicator 221 via the network 400. The controller 223 of the charging control apparatus 220 obtains the third identifier by selecting a charger 210 that can be secured in the charging reservation period T_{RES} as appropriate. In addition, an identifier (third identifier) of the charger 210 selected by the controller 223 may be transmitted to the external system 300 as a response. The third identifier obtained in this manner is used as the third identifier in step S102 and the later steps instead of the third identifier transmitted from the first external device 310.

In step S106 according to the first to third embodiments described above, the second external device 320 transmits the first and second identifiers to the communicator 221 via the network 400.

In step S106 according to a modification of the first to third embodiments, the second external device 320 transmits the second identifier to the communicator 221 via the network 400. The controller 223 of the charging control apparatus 220 obtains the first identifier by identifying the charging schedule corresponding to the charging reservation period T_{RES} on the basis of a fact that connection of an electric vehicle 500 to the charger 210 indicated by the second identifier in the time period (charging reservation period T_{RES}) is approvable (a fact that the second identifier has been transmitted). The first identifier obtained in this manner is used as the first identifier in step S107 and the later steps instead of the first identifier transmitted from the second external device 320.

In the first to third embodiments described above, steps S103 to S107 may be performed after steps S101 and S102 are performed. Steps S101 and S102 may be performed after steps S103 to S107 are performed.

### Method and System Understood from Above Description

As can be understood from the above description, the present disclosure discloses a charging control method. Specifically, the charging control method is performed by the charging control apparatus 220.

In an example, the charging control method includes a first step, a second step, and a third step. In the first step, when an electric vehicle 500 is connected to a charger 210, a first identifier is received from the first external device 310. The first identifier is an identifier for identifying a charging schedule planned in advance for the electric vehicle 500. In the second step, a second identifier is received from the second external device 320. The second identifier is an identifier of the charger 210 to which the electric vehicle 500 is connected. In the third step, whether the second identifier and the third identifier are the same is determined. The third identifier is an identifier of a charger 210 scheduled to be used in the charging schedule. The third identifier is associated with the first identifier. In the charging control method, even if the second identifier and the third identifier are different from each other, the charger 210 to which the electric vehicle 500 is connected performs charging control for the electric vehicle 500. This configuration is suitable for improving convenience of a user of the electric vehicle 500.

In the above configuration, "charging control for the electric vehicle 500" specifically accompanies charging of the electric vehicle 500 by supplying a current to the electric vehicle 500.

The expression "when an electric vehicle 500 is connected to a charger 210, a first identifier is received from the first external device 310" in the above configuration will be described. This expression encompasses a mode in which the first identifier is received from the first external device 310 before the electric vehicle 500 is connected to the charger 210, a mode in which the first identifier is received from the first external device 310 at the same time as the electric vehicle 500 is connected to the charger 210, and a mode in which the first identifier is received from the first external device 310 after the electric vehicle 500 is connected to the charger 210. Typically, the first identifier is received from the first external device 310 when, for example, a charging reservation is made, that is, before the electric vehicle 500 is connected to the charger 210. In the above configuration, "electric vehicle 500" in "charging schedule planned in advance for the electric vehicle 500" can be the electric vehicle 500_{RES} in the first to third embodiments. "Charger 210 to which the electric vehicle 500 is connected" can be the charger 210_{CON} in the first to third embodiments. "Charger 210 scheduled to be used in the charging schedule" can be the charger 210_{RES} in the first to third embodiments.

In an example, the charging control method includes a fourth step. In the fourth step, if the second identifier and the third identifier are different from each other, information indicating an abnormality is transmitted to the third external device 330. With this configuration, the third external device 330 can address the abnormality.

In an example, the charging control method includes a fifth step. In the fifth step, if the second identifier and the third identifier are different from each other, information indicating that the charger 210 scheduled to be used in the charging schedule and the charger 210 actually connected to the electric vehicle 500 are different from each other is transmitted to the third external device 330. With this configuration, the third external device 330 can address the abnormality.

In an example, the charging control method includes a sixth step. In the sixth step, if the second identifier and the third identifier are different from each other, information indicating that the charging schedule needs to be corrected is transmitted to the third external device 330. With this configuration, the third external device 330 can address the abnormality.

In an example, the first identifier is also associated with time information regarding the charging schedule. That is, the time information regarding the charging schedule can be referred to using the first identifier. Specifically, the time information regarding the charging schedule indicates a period for which charging is scheduled to be performed. More specifically, the time information regarding the charging schedule includes information regarding a period for which charging is scheduled to be performed. Specifically, the time information regarding the charging schedule includes information indicating a start time and an end time of a period for which charging is scheduled to be performed.

As can be understood from the above description, the present disclosure discloses the charging control apparatus 220.

The charging control apparatus 220 includes a communicator 221, a storage 222, and a controller 223. The communicator 221 communicates with a first external device 310 or a second external device 320.

In an example, the storage 222 stores a first identifier and a third identifier in association with each other. The first identifier is an identifier for identifying a charging schedule planned in advance for an electric vehicle 500. The third identifier is an identifier of a charger 210 scheduled to be used in the charging schedule. When an electric vehicle 500 is connected to the charger 210, the controller 223 receives the first identifier from the first external device 310 via the communicator 221, and receives a second identifier from the second external device 320 via the communicator 221. The second identifier is an identifier of the charger 210 to which the electric vehicle 500 is connected. Upon the reception, the controller 223 determines whether the second identifier and the third identifier are the same. The third identifier is associated with the first identifier. Even if the second identifier and the third identifier are different from each other, the controller 223 causes the charger 210 to which the electric vehicle 500 is connected to perform charging control for the electric vehicle 500.

### Appendix

The above description of embodiments discloses the following techniques.

### Technique 1

A charging control method including: receiving, from a first external device when an electric vehicle is connected to a charger, a first identifier for identifying a charging schedule planned in advance for the electric vehicle; receiving, from a second external device, a second identifier of the charger to which the electric vehicle is connected; and determining whether the second identifier and a third identifier of a charger scheduled to be used in the charging schedule associated with the first identifier are same, in which, even if the second identifier and the third identifier are different from each other, the charger to which the electric vehicle is connected performs charging control for the electric vehicle.

### Technique 2

The charging control method according to technique 1, further including: transmitting, if the second identifier and the third identifier are different from each other, information indicating an abnormality to a third external device.

### Technique 3

The charging control method according to technique 1 or 2, further including: transmitting, if the second identifier and the third identifier are different from each other, information indicating that the charger scheduled to be used in the charging schedule and the charger to which the electric vehicle is actually connected are different from each other to a third external device.

### Technique 4

The charging control method according to any of techniques 1 to 3, further including: transmitting, if the second identifier and the third identifier are different from each other, information indicating that the charging schedule needs to be corrected to a third external device.

### Technique 5

The charging control method according to any of techniques 1 to 4, in which the first identifier is also associated with time information regarding the charging schedule.

### Technique 6

A charging control apparatus including: a communicator that communicates with a first external device or a second external device; a storage that stores a first identifier for identifying a charging schedule planned in advance for an electric vehicle and a third identifier of a charger scheduled to be used in the charging schedule in association with each other; and a controller that receives, when the electric vehicle is connected to a charger, the first identifier from the first external device via the communicator, determines, when a second identifier of the charger to which the electric vehicle is connected is received from the second external device via the communicator, whether the second identifier and a third identifier associated with the first identifier are same, and causes, even if the second identifier and the third identifier are different from each other, the charger to which the electric vehicle is connected to perform charging control for the electric vehicle.

The techniques according to the present disclosure can be used when, for example, a charging system and a dispatch system operate in coordination with each other.

What is claimed is:

1. A charging control method comprising:
receiving, from a first external device when an electric vehicle is connected to a charger, a first identifier for identifying a charging schedule planned in advance for the electric vehicle;
receiving, from a second external device, a second identifier of the charger to which the electric vehicle is connected; and
determining whether the second identifier and a third identifier of a charger scheduled to be used in the charging schedule associated with the first identifier are same,
wherein, even if the second identifier and the third identifier are different from each other, the charger to which the electric vehicle is connected performs charging control for the electric vehicle.

2. The charging control method according to claim 1, further comprising:
transmitting, if the second identifier and the third identifier are different from each other, information indicating an abnormality to a third external device.

3. The charging control method according to claim 1, further comprising:
transmitting, if the second identifier and the third identifier are different from each other, information indicating that the charger scheduled to be used in the charging schedule and the charger to which the electric vehicle is actually connected are different from each other to a third external device.

4. The charging control method according to claim 1, further comprising:
transmitting, if the second identifier and the third identifier are different from each other, information indicating that the charging schedule needs to be corrected to a third external device.

5. The charging control method according to claim 1,
wherein the first identifier is also associated with time information regarding the charging schedule.

6. A charging control apparatus comprising:
a communicator that communicates with a first external device or a second external device;
a storage that stores a first identifier for identifying a charging schedule planned in advance for an electric vehicle and a third identifier of a charger scheduled to be used in the charging schedule in association with each other; and
a controller that receives, when the electric vehicle is connected to a charger, the first identifier from the first external device via the communicator, determines, when a second identifier of the charger to which the electric vehicle is connected is received from the second external device via the communicator, whether the second identifier and a third identifier associated with the first identifier are same, and causes, even if the second identifier and the third identifier are different from each other, the charger to which the electric vehicle is connected to perform charging control for the electric vehicle.
